(19) United States
(12) Patent Application Publication
(10) Pub. No.: US 2017/0143583 A1
(43) Pub. Date: May 25, 2017

(54) MASSAGING VIBRATION DEVICE AND MASSAGING ASSEMBLY INCLUDING SAME

(71) Applicant: YUNG-CHIH LIN, TAINAN CITY 718 (TW)

(72) Inventor: YUNG-CHIH LIN, TAINAN CITY 718 (TW)

(21) Appl. No.: 14/947,047

(22) Filed: Nov. 20, 2015

(51) Int. Cl. A61H 23/02; A61H 15/00

(52) U.S. Cl. CPC A61H 23/02; A61H 15/0092; A61H 2015/0014

(57) ABSTRACT

A massaging vibration device includes a cylinder and an outer enveloping member. A vibratory motor is mounted in the cylinder. The outer enveloping member is made of soft elastic material. The outer enveloping member envelops and is fixed around the cylinder. An overall outer diameter of the outer enveloping member assembled with the cylinder is smaller than 14 cm. The massaging vibration device can be mounted in a massaging roller to provide the massaging roller with a vibrating effect.

### BACKGROUND OF THE INVENTION

The present invention relates to a massaging device and, more particularly, to a massaging vibration device and a massaging assembly including the massaging vibration device.

Due to the popularity of workout, more people begin to exercise and proceed with activities for keeping the body healthy. Tension of muscles and fasciae often occurs after exercise training or due to imbalanced gestures in daily lives, leading to pain. Therefore, many people add stretching and massaging programs after the exercise training to relax the muscles and fasciae, strengthening the balance of the muscle system, reducing the pain of the body, and increasing the exercising performances.

Various massaging devices are used during massage of muscles. A massaging roller is commonly used and generally includes a rigid hollow tube enveloped by a soft outer layer. The hollow tube is designed to reduce the overall weight of the massaging roller. Protrusions are provided on an outer periphery of the soft outer layer to increase the pressing effect of the massaging roller.

However, the conventional massaging roller must be pressed and rolled by an operator to provide the massaging effect. Furthermore, static pressing cannot provide more stimulation to the muscles and the fasciae.

Thus, a need exists for a novel massaging device that mitigates and/or obviates the above disadvantages.

### BRIEF SUMMARY OF THE INVENTION

In a first aspect, a massaging vibration device includes a cylinder and an outer enveloping member. A vibratory motor is mounted in the cylinder. The outer enveloping member is made of soft elastic material. The outer enveloping member envelops and is fixed around the cylinder. An overall outer diameter of the outer enveloping member assembled with the cylinder is smaller than 14 cm.

In a second aspect, a massaging vibration device is used in a massaging roller to provide the massaging roller with a vibrating effect. The massaging vibration device includes a cylinder and an outer enveloping member. A vibratory motor is mounted in the cylinder. The outer enveloping member is made of soft elastic material. The outer enveloping member envelops and is fixed around the cylinder. An overall outer diameter of the outer enveloping member assembled with the cylinder is smaller than 14 cm.

In a third aspect, a massaging assembly includes a cylinder, an outer enveloping member, and a massaging roller. A vibrating motor is mounted in the cylinder. The outer enveloping member is made of soft elastic material. The outer enveloping member envelops and is fixed around the cylinder. An overall outer diameter of the outer enveloping member assembled with the cylinder is smaller than 14 cm. The massaging roller is mounted around the outer enveloping member.

An overall axial length of the outer enveloping member assembled with the cylinder can be smaller than 38 cm.

The outer enveloping member can have a thickness smaller than the radius of the cylinder. The cylinder can have an axial length larger than the overall outer diameter of the outer enveloping member assembled with the cylinder.

The outer enveloping member can include an outer periphery with a plurality of protrusions.

The cylinder can further receive a battery. A switch can be mounted to one of two ends of the cylinder and can be electrically connected to the vibratory motor. The battery is a rechargeable battery or a lithium battery. A charging plug is mounted to one of the two ends of the cylinder.

The soft elastic material of the outer enveloping member can be a foam material.

The present invention will become clearer in light of the following detailed description of illustrative embodiments of this invention described in connection with the drawings.

### DESCRIPTION OF THE DRAWINGS

FIG. 1 is an exploded, perspective view of a massaging vibrating device according to the present invention.

FIG. 2 is an exploded, perspective view of the massaging vibrating device according to the present invention and a massaging roller.

FIG. 3 is a perspective view of a massaging assembly obtained after assembly of the massaging vibrating device and the massaging of FIG. 2.

FIG. 4 is a cross sectional view taken along section line A-A of FIG. 3.

FIG. 5 is a schematic view illustrating use of the massaging assembly.

FIG. 6 is a block diagram illustrating electrical connection of components of the massaging vibration device.

### DETAILED DESCRIPTION OF THE INVENTION

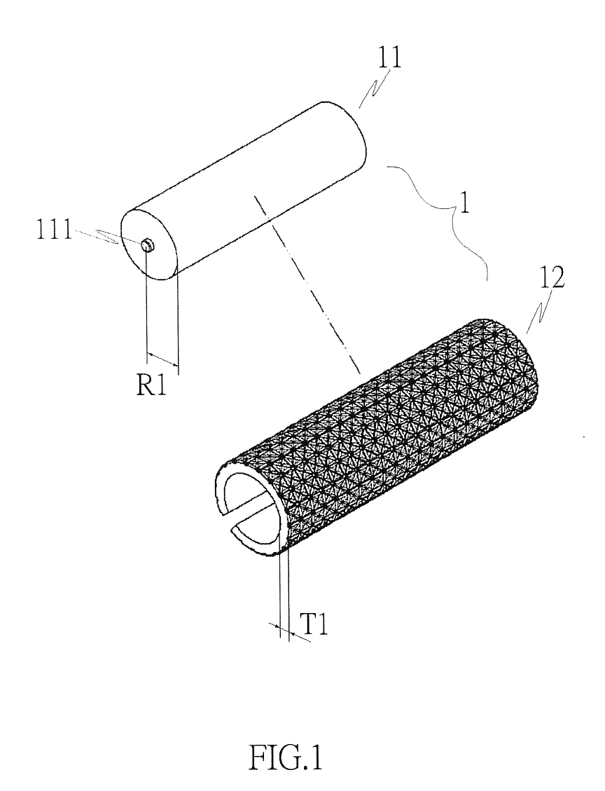

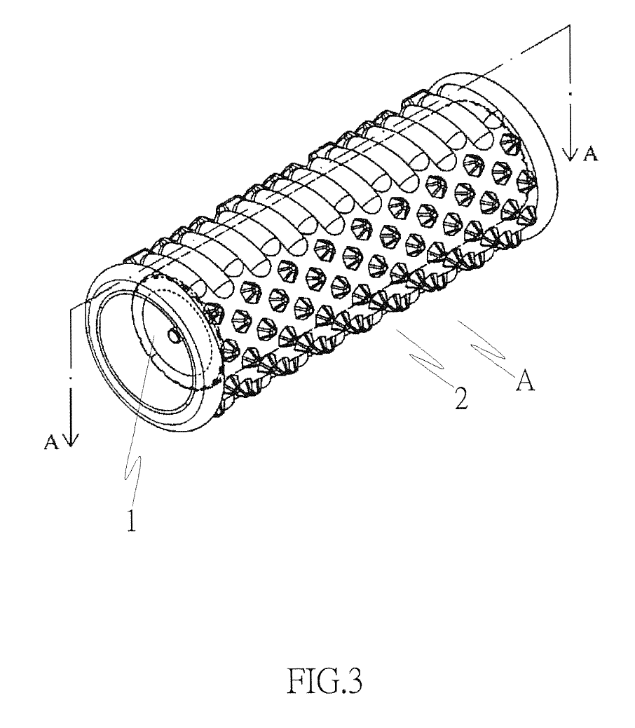

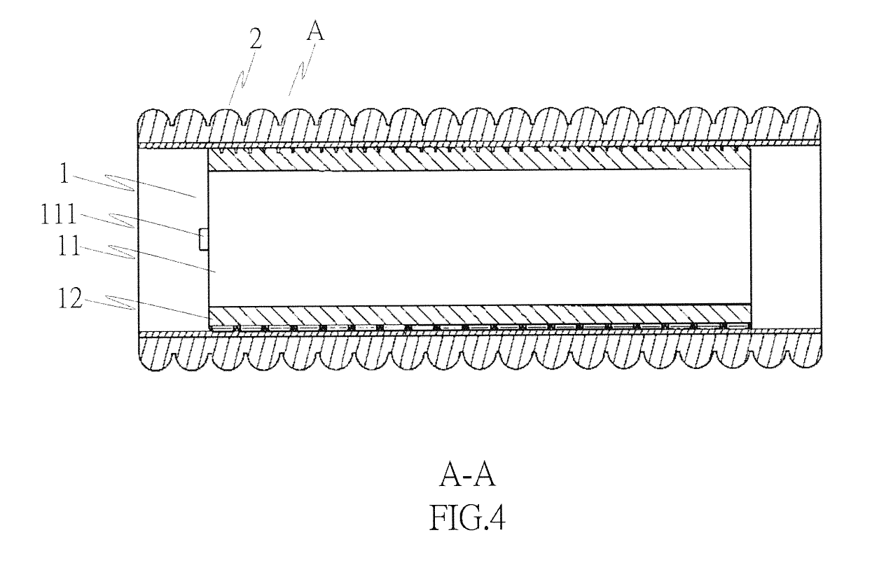

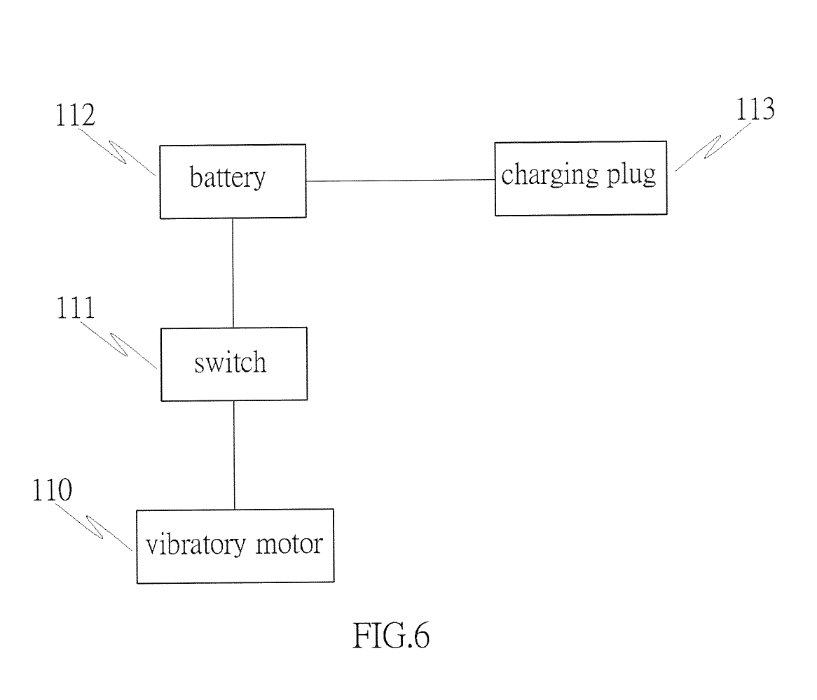

With reference to FIGS. 1-4 and 6, a massaging vibration device 1 according to the present invention can be used in a massaging roller 2 to provide the massaging roller 2 with a vibrating effect. The massaging vibration device 1 includes a cylinder 11. The cylinder 11 receives a vibratory motor 110 and a battery 112. A switch 111 is mounted to one of two ends of the cylinder 11 and is electrically connected to the vibratory motor 110 for activating or stopping the vibratory motor 110. In a preferred example, the battery 112 is a rechargeable battery or a lithium battery. Furthermore, a charging plug 113 can be mounted to one of the two ends of the cylinder for charging the rechargeable battery or the lithium battery.

Furthermore, the massaging vibration device 1 includes an outer enveloping member 12 made of soft elastic material. The soft elastic material can be a foam material, such as ethylene vinyl acetate (EVA), polyethylene (PE), or nitrile-butadiene rubber (NBR). The outer enveloping member 12 envelopes and is fixed around the cylinder 11 by gluing or any other suitable provision. When the outer enveloping member 12 of the massaging vibration device 1 is mounted in the massaging roller 2, the properties of the soft elastic material permit the outer enveloping member 12 to tightly press against an inner periphery of the massaging roller 2, such that the cylinder can be fixed in relation to the massaging roller 2.

Since the diameter of the massaging roller 2 is associated with the extent of stimulation to the soft tissues of the pressed portion of the user (the larger the diameter of the massaging roller 2, the lower the extent of stimulation), to provide the human soft tissues with a suitable extent of stimulation and due to limitation in the manufacturing process and the machinery, according to years of experience and observation by the Applicant, it was found that the inner diameters of the currently available massaging rollers are preferably not larger than 14 cm (the extent of stimulation is often too small when the inner diameters of the massaging rollers exceed 14 cm).

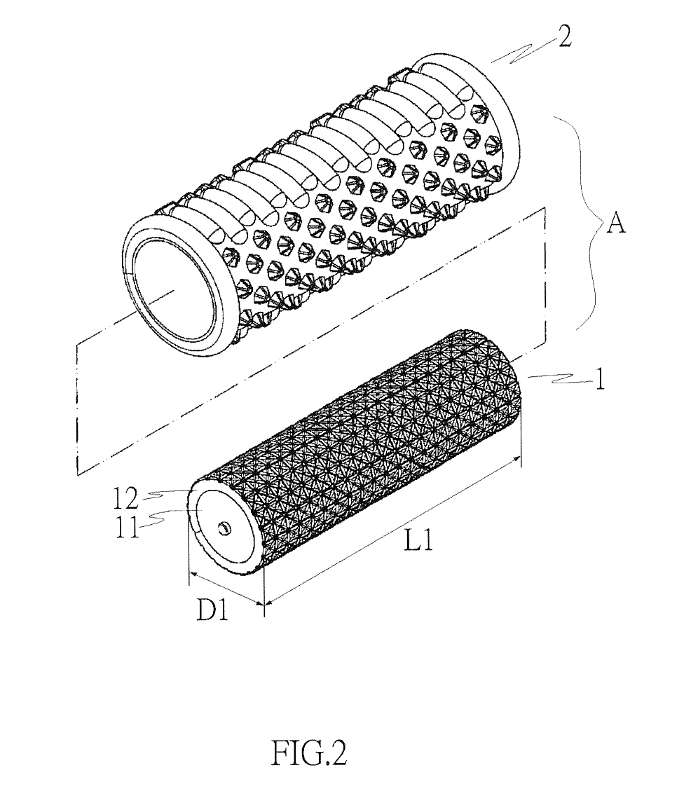

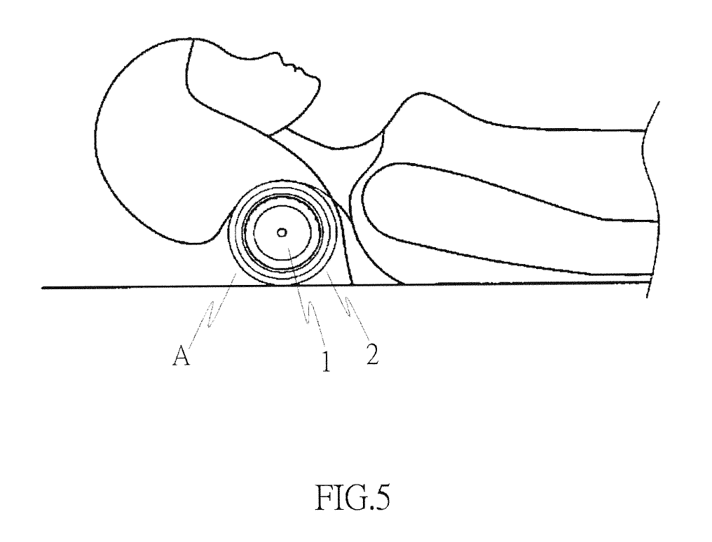

With reference to FIGS. 2 and 2, to match with the specification of the currently available massaging rollers, the overall outer diameter D1 of the outer enveloping member 12 assembled with the cylinder 1 is smaller than 14 cm. Thus, the outer enveloping member 12 can be mounted in a currently available roller 2 to form a massaging assembly A. With reference to FIG. 5, when the massaging vibration device 1 is used together with a massaging roller 2, in addition to the inherent static pressing function, the massaging roller 2 can provide a vibrating effect through the massaging vibration device 1 according to the present invention, increasing the stimulating effect to the human soft tissues.

Furthermore, when the size of the massaging vibration device 1 is too small, an excessively large gap is apt to exist between the massaging vibration device 1 and the massaging roller 2, such that the massaging vibration device 1 cannot tightly press against the inner periphery of the massaging roller 2. As a result, the massaging roller 2 generates uneven and irregular twitches when the massaging vibration device 1 operates, which could be harmful to the human body. According to years of experience of the Applicant, when the diameter of the massaging vibration device 1 is smaller than 8 cm, the massaging roller 2 is apt to generate irregular twitches. Thus, the outer diameter D1 of the outer enveloping member 12 assembled with the cylinder 1 is not smaller than 8 cm to prevent the excessively large gap between the massaging roller 2 and the massaging vibration device 1.

It is noted that the massaging vibration device 1 does not have to assemble with the massaging roller 2 to form the massaging assembly A. Namely, the massaging vibration device 1 alone can serve as an independent vibratory massaging roller with a smaller diameter, providing a larger extent of stimulating while permitting easy carriage.

When the axial length of the massaging vibration device 1 is too long, irregular twitches are liable to occur during operation due to uneven distribution of weight. However, the overall weight of the massaging vibration device 1 is increased if the mass of a portion of the massaging vibration device 1 is increased. Thus, the weight of the massaging vibration device 1 is maintained to be smaller than a certain extent to assure the balance and stability during operation of the massaging vibration device 1. In a preferred example, the overall axial length of the outer enveloping member 12 assembled with the cylinder 11 is smaller than 38 cm.

When the thickness of the outer enveloping member 12 is too large, the vibrations are able to be excessively buffered, greatly decreasing the vibrating effect of the cylinder 11. In a preferred example for maintaining the vibrating effect of the massaging vibration device 1, the thickness T1 of the outer enveloping member 12 is smaller than the radius RI of the cylinder 11, and the axial length L1 of the cylinder 11 is larger than the overall outer diameter D1 of the outer enveloping member 12 assembled with the cylinder 11.

In a preferred example, protrusions are provided on an outer periphery of the outer enveloping member 12 to increase the friction between the outer enveloping member 12 and the inner periphery of the massaging roller 2, increasing the positioning effect. Note that recessed portions are defined between the protrusions.

Although specific embodiments have been illustrated and described, numerous modifications and variations are still possible without departing from the scope of the invention. The scope of the invention is limited by the accompanying claims.

What is claimed is:

1. A massaging vibration device comprising:
a cylinder, with a vibratory motor mounted in the cylinder; and
an outer enveloping member made of soft elastic material, with the outer enveloping member enveloping and fixed around the cylinder, and with an overall outer diameter of the outer enveloping member assembled with the cylinder being smaller than 14 cm.

2. The massaging vibration device as claimed in claim 1, wherein an overall axial length of the outer enveloping member assembled with the cylinder is smaller than 38 cm.

3. The massaging vibration device as claimed in claim 2, wherein the outer enveloping member has a thickness smaller than a radius of the cylinder, and wherein the cylinder has an axial length larger than the overall outer diameter of the outer enveloping member assembled with the cylinder.

4. The massaging vibration device as claimed in claim 3, wherein the outer enveloping member includes an outer periphery with a plurality of protrusions.

5. The massaging vibration device as claimed in claim 3, with the cylinder further receiving a battery, with the cylinder including two ends, and with a switch mounted to one of the two ends of the cylinder and electrically connected to the vibratory motor.

6. The massaging vibration device as claimed in claim 5, wherein the battery is a rechargeable battery or a lithium battery, and wherein a charging plug is mounted to one of the two ends of the cylinder.

7. The massaging vibration device as claimed in claim 3, wherein the soft elastic material of the outer enveloping member is a foam material.

8. A massaging vibration device for use in a massaging roller to provide the massaging roller with a vibrating effect, with the massaging vibration device comprising:
a cylinder, with a vibrating motor mounted in the cylinder; and
an outer enveloping member made of soft elastic material, with the outer enveloping member enveloping and fixed around the cylinder, and with an overall outer diameter of the outer enveloping member assembled with the cylinder being smaller than 14 cm.

9. The massaging vibration device as claimed in claim 8, wherein an overall axial length of the outer enveloping member assembled with the cylinder is smaller than 38 cm.

10. The massaging vibration device as claimed in claim 9, wherein the outer enveloping member has a thickness smaller than a radius of the cylinder, and wherein the cylinder has an axial length larger than the overall outer diameter of the outer enveloping member assembled with the cylinder.

11. The massaging vibration device as claimed in claim 10, wherein the outer enveloping member includes an outer periphery with a plurality of protrusions.

12. The massaging vibration device as claimed in claim 10, with the cylinder further receiving a battery, with the cylinder including two ends, and with a switch mounted to one of the two ends of the cylinder and electrically connected to the vibratory motor.

13. The massaging vibration device as claimed in claim 12, wherein the battery is a rechargeable battery or a lithium battery, and wherein a charging plug is mounted to one of the two ends of the cylinder.

14. The massaging vibration device as claimed in claim 10, wherein the soft elastic material of the outer enveloping member is a foam material.

15. A massaging assembly comprising:
a cylinder, with a vibrating motor mounted in the cylinder;
an outer enveloping member made of soft elastic material, with the outer enveloping member enveloping and fixed around the cylinder, and with an overall outer diameter of the outer enveloping member assembled with the cylinder being smaller than 14 cm; and
a massaging roller mounted around the outer enveloping member.

16. The massaging assembly as claimed in claim 15, wherein an overall axial length of the outer enveloping member assembled with the cylinder is smaller than 38 cm.

17. The massaging assembly as claimed in claim 16, wherein the outer enveloping member has a thickness smaller than a radius of the cylinder, and wherein the cylinder has an axial length larger than the overall outer diameter of the outer enveloping member assembled with the cylinder.

18. The massaging assembly as claimed in claim 17, wherein the outer enveloping member includes an outer periphery with a plurality of protrusions.

19. The massaging assembly as claimed in claim 17, with the cylinder further receiving a battery, with the cylinder including two ends, and with a switch mounted to one of the two ends of the cylinder and electrically connected to the vibratory motor.

20. The massaging assembly as claimed in claim 19, wherein the soft elastic material of the outer enveloping member is a foam material.
